(19) United States
(12) Patent Application Publication
(10) Pub. No.: US 2005/0258633 A1
(43) Pub. Date: Nov. 24, 2005

(54) Coloring book with elevated outline portions

(76) Inventors: Mary Christine Hilicki, Brentwood, TN (US); Richard Hilicki, Brentwood, TN (US)

Correspondence Address: FISH & NEAVE IP GROUP;ROPES & GRAY LLP, 1251 AVENUE OF THE AMERICAS FL C3, NEW YORK, NY, 10020-1105, US

(21) Appl. No.: 11/099,736

(22) Filed: Apr. 5, 2005

Related U.S. Application Data
(60) Provisional application No. 60/559,746, filed on Apr. 5, 2004.

(51) Int. Cl. B42D 15/00

(52) U.S. Cl. 283/63.1

(57) ABSTRACT

A coloring book is provided with elevated portions located on each coloring page. The elevated portions may define the outline of images on the coloring pages for users to color. The elevated portions may be fabricated from a black velvet such that a user is provided resistance when trying to color “outside the lines” of the outline created by the elevated portions. The coloring book may include additional features such as, for example, a musical system, transparent film revealing hidden drawings, coloring instrument holders, or any other suitable additional feature.

This application claims the benefit of U.S. provisional application No. 60/559,746, filed Apr. 5, 2004, which is incorporated by reference herein in its entirety.

### BACKGROUND OF THE INVENTION

The present invention relates to coloring books. In particular, the present invention relates to coloring books for users, such as children, who have trouble coloring within the lines defining an image of a coloring book.

Traditional coloring books allow users', and in particular children's, hand-eye coordination and imagination to improve. Typical coloring books include a cover and multiple interior sheets onto which an outline defining an image is printed. A user may then color the various portions within the outlines to create a colored image.

Yet, users lacking the appropriate level of hand-eye coordination, such as young users, may find difficulty in coloring within the lines of an image printed on a sheet of a coloring book. Such users may become frustrated as a result of not being able to color an image as desired. Thus, traditional coloring books are deficient.

It would therefore be desirable to provide a coloring book that facilitates coloring within the lines of an image. It would also be desirable to provide a coloring book with additional features that may improve hand-eye coordination and increase the whimsical and festive nature of the coloring book.

### SUMMARY OF THE INVENTION

A coloring book for helping a user color within the lines of an image is provided. The characteristic of these colorable images may be changed by a user such that images for helping the user stay within the lines of the image are provided. Similarly, the coloring book may be operable to allow a user to create such easy to color images. Additional features are provided that increase the whimsical and festive nature of the coloring book.

In one embodiment of the present invention, a coloring book is provided that may include a book cover and an interior sheet. The interior sheet may include a first page and a second page. Particularly, a fold line may be included on the interior sheet that defines the first page and the second page. Alternatively, the interior sheet may be formed by fixing multiple pages together, such as stapling, binding, or gluing two pages together. The first page may include one or more images, the outlines of which may be defined by one or more elevated portions attached to the first page. Similarly, the second page may include one or more images, the outlines of which may be defined by one or more elevated portions attached to the second page.

An elevated portion for use in an easy-to-color coloring book may be fabricated from a velvet material, plastic, paper, or any other suitable material. The elevated portion may be fabricated in a variety of colors to achieve a variety of function such as, for example, the elevated portion may be dark in color, light in color, or any other suitable color. A dark color may hide any unwanted marks outside the image so that the quality of a colored image may be increased. A light color may highlight coloring errors such that a user can learn from mistakes made. An elevated portion may be permanently fixed or removably attached to the page. Thus, a light colored elevated portion may be removed after the image has been colored. Generally, an elevated portion is provided such that when a coloring instrument abuts the elevated portion, the coloring instrument is forced to not overstep the elevated portion. Thus, an elevated portion guides misguided marks so that an image is colored within the lines (e.g., within the elevated outline portions).

Coloring instruments may be provided with the coloring book. Such coloring instruments may include, for example, crayons, pencils, pens, markers, chalk, or any other suitable coloring instrument. The coloring instruments may be attached to the coloring book directly, or attached via a coloring instrument holder.

In some embodiments, a coloring book is provided that includes circuitry or components for producing sounds. Such a sound may take the form of, for example, a musical tune, ring, song, voice, or any other suitable sound. The circuitry or components may be activated mechanically (e.g., an on/off switch), by light (e.g., via a photoelectronic such as a photodiode or photoresistor), or by any other suitable type of actuation. The circuitry or components may be incorporated in the book cover, in an interior sheet, or in any other suitable location.

In some embodiments, the coloring book may include a circuitry or components for producing light. Such circuitry or components may be activated type of actuation. The circuitry or components may be incorporated anywhere in a book, including, for example, the book's cover, in an interior sheet, or in any other suitable location.

In another embodiment, a coloring book is provided that includes a film configured to reveal an image hidden in a portion of the coloring book. The image may be revealed by placing the film over the image. The film may be colored and may be translucent in order to assist in an image-revealing process.

The coloring books of the present invention may also include a coloring instrument holder. The holder may be closable and/or reusable. The holder may be located on the book cover, on an interior sheet, or at any other suitable location of the coloring book.

### BRIEF DESCRIPTION OF THE DRAWINGS

The above and other objects and advantages of the present invention will be apparent upon consideration of the following detailed description, taken in conjunction with accompanying drawings, in which like reference characters refer to like parts throughout, and in which:

FIG. 1 is a schematic view of an illustrative coloring sheet of a coloring book in accordance with the principles of the present invention;

FIG. 2 is a schematic view of an illustrative elevated portion sheet in accordance with the principles of the present invention;

FIG. 3 is a schematic view of an illustrative coloring page with an elevated portion attached thereto in accordance with the principles of the present invention;

FIG. 4 is a schematic view of an illustrative coloring page with a sticker portion and an elevated portion in accordance with the principles of the present invention;

FIG. 5 is a schematic view of an illustrative cover of a coloring book in accordance with the principles of the present invention;

FIGS. 6A and 6B are illustrative systems for activating sound and light effects in accordance with the principles of the present invention;

FIGS. 7A to 7C are illustrative schematic views of the use of a film in accordance with the principles of the present invention; and

FIG. 8 is an exploded view of a coloring book in accordance with the principles of the present invention.

### DETAILED DESCRIPTION

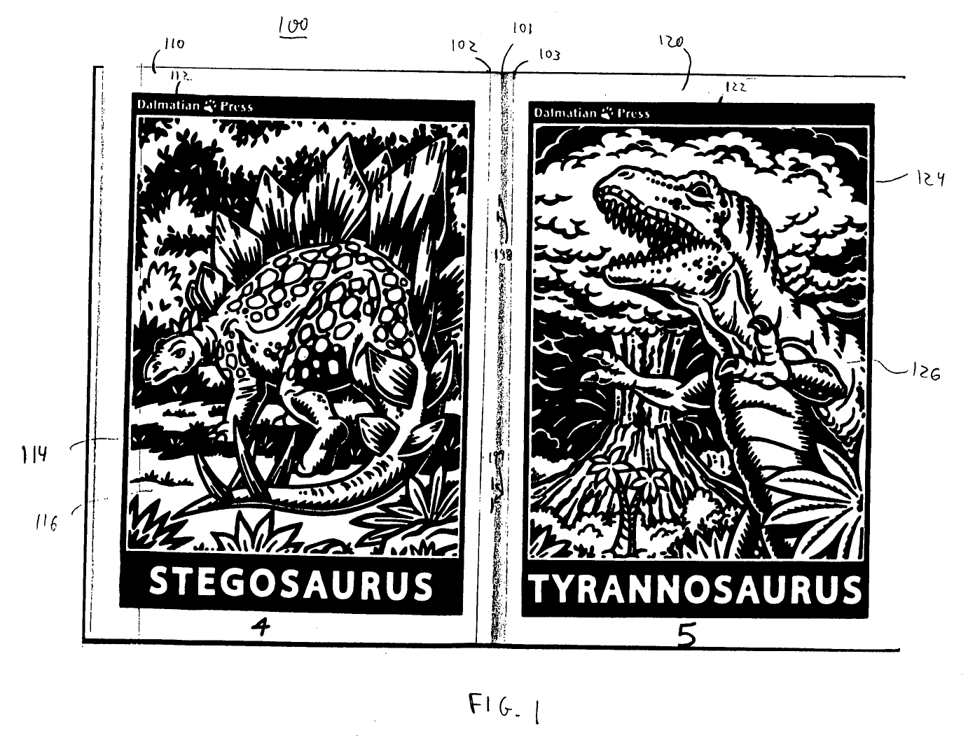

FIG. 1 shows coloring book sheet 100 that may include two coloring book pages 110 and 120. Multiple sheets 100 may be bound together to form a book of sheets 100. In this manner, sheet 100 may be an interior sheet of a book. In some embodiments, sheet 100 may be folded along a fold line such as fold line 101 to define pages 110 and 120.

Multiple interior coloring book sheets such as sheet 100 may be combined by, for example, attaching the sheets at the fold lines after the fold lines are aligned to form a book. A cover may be bound to the sheets with, for example, one or more staples, a glue, or through sewing or any other suitable binding. In some embodiments, staples 198 and 199 may be used to fix sheet 100 to other sheets and/or a cover. The process of fabricating the coloring book may be automated, and may be similar or identical to the one used for fabricating any other book.

Sheet 100 may include perforations 102 and 103 parallel to fold line 101 such that perforations 102 and 103 are located between coloring pages 110 and 120 and fold line 101, respectively, or on pages 110 and 120. Perforations 102 and 103 may, for example, allow a user to easily remove pages 110 and 120 from sheet 100 such that pages 110 and 120 may be displayed.

Sheet 100 may be fabricated to any suitable size. In some embodiments, the dimensions of sheet 100 may be configured to remain consistent with traditional book formats. For example, the dimensions of sheet 100 may be 8.5×11″, 4×6″, 5×7″, 10×13″, or any other suitable dimension. Alternatively, page 110 or page 120 are, for example, 8.5×11″, 4×6″, 5×7″, 10×13″, or any other suitable dimension. Sheet 100 or page 110 or page 120 may be fabricated from any material such as, for example, a paper or cardboard. The material may chosen so that the book may be assembled by traditional methods and machinery, or by improved methods and machinery described herein.

Pages 110 and 120 may include images 112 and 122. Pages 110 and 120 may include elevated portions 114 and 124 to, for example, define image 112 and 122. In this manner, elevated portions 114 and 124 may be attached to page 110 or page 120. Elevated portions 114 and 124 may define clear, or unobstructed, spaces 116 and 126, that may be colored by a user. More particularly, the elevated portions may obstruct portions of a page so the portion may not be directly colored by a user. As a result, a user is influenced to color the unobstructed portions of the page, the portions between the elevated portions. A user coloring such unobstructed positions is physically forced to stay within the unobstructed portions because when a coloring instrument attempts to go to an elevated portion, the elevated portion may abut the coloring instrument, thus applying a force against movement on the obstructed portion. Thus images 112 and 122 may, for example, be formed, at least in part, by unobstructed portions 116 and 126 of a page defined by elevated portions 114 and 124.

Images 116 and 126 may be any image suitable for coloring. In particular, the image may be, for example, a dinosaur, television character, toy, personalities, letters, numbers, or any other image that a user may desire to color.

The reverse side (e.g., the back side) of pages 110 and 120 may be left unobstructed (e.g., left free of elevated portions) for a variety of reasons. First, such pages 110 and 120 may be easily employed as posters, being easily attachable to a wall. Alternatively, leaving the reverse side blank may reduce manufacturing costs. A user may remove pages 110 and 120 from the coloring book by cutting or tearing sheet 100 at perforations 102 and 103, respectively. Alternately, the reverse side of one or both pages may include an image that does not include elevated portions. Such an image may be defined by, for example, lines printed on the reverse side to define the image. Still alternately, the reverse side of one or both pages may include an image defined by elevated portions.

Elevated portions 114 and 124 may be configured to extend from pages 110 and 120, respectively, such that a user may abut the elevated portion with a coloring instrument upon approaching the elevated portion while coloring clear (e.g., unobstructed) spaces 116 and 126. Elevated portions 114 and 124 may be configured to have a particular height such that a user may have difficulty overstepping the elevated portion to color outside of the lines that define the image. The elevated portions may be made from any suitable material such as, for example, paper, cardboard, velvet, plastic, Teflon, felt, Velcro, or any other suitable material.

Elevated portions 114 and 124 may be any suitable color. In some embodiments, the elevated portions may be a dark color, such as black, navy blue, dark gray, or any other suitable dark color. The dark color may advantageously allow a user to accidentally color the elevated portion with a coloring instrument without creating a visible mark. In some embodiments, the elevated portion may be a light color, or the same color as clear (e.g., unobstructed) spaces 116 and 126. Such an embodiment may allow a user to color elevated portions 114 and 124 as well as the clear spaces. In some embodiments, the elevated portions may be a combination of dark colors, light colors, or dark and light colors. In some embodiments, the elevated portions may include a pattern or a printed image or text.

Elevated portions 114 and 124 may be attached to coloring pages 110 and 120, respectively, by any suitable method. For example, elevated portions 114 and 124 may be permanently fixed to coloring pages 110 and 120, respectively. Accordingly, elevated portions 114 and 124 may be coated with any suitable permanent bonding material such as, for example, glue or tape, or bound in any way such as by heat treatment, sewing, ultrasonic bonding, or any other suitable permanent type of bonding.

Alternatively, one or more elevated portions 114 and 124 may be removably attached to pages 110 and 120, respectively. Elevated portions 114 and 124, or portions of elevated portions 114 and 124, may be coated with any suitable permanent or temporary binding material such as, for example, glue, tape, static cling, magnetic attraction, snaps, Velcro, or any other suitable detachable mechanism. Such a permanent or temporary binding material may be located entirely on elevated portions 114 and 124, entirely on coloring pages 110 and 120, or on both the elevated portions and the page.

Elevated portions 114 and 124 may include one or more male connectors (not shown) and pages 110 and 120 may include one or more female connectors (not shown) such that the male connector of elevated portions 114 and 124 may be inserted into and removed from (or permanently attached to) the female connector of pages 110 and 120, respectively. Thus, a puzzle dynamic may be added to the coloring book.

A user may use any suitable coloring instrument to color unobstructed spaces 116 and 126 (which may be defined by, for example, elevated portions 114 and 124). Suitable coloring instruments may include, for example, crayons, markers, pens, pencils, paint, ink pad, stamps, or any other suitable coloring instrument. Alternatively, a glue may be used from any suitable glue dispenser to which glitter of various colors may be applied. The user may place glue inside the image defined by the elevated portion and place colored glitter on the glue. All such instruments may be attached to any portion of the book for distribution. A coloring instrument (not shown) may alternately house any of these coloring instruments. The container may be attached to the book (e.g., glued to the book's cover).

In some embodiments, the coloring book may include only three sheets. A first sheet may serve as a cover for the book. For example, the first sheet may be a cardboard like material The first sheet may include images on one surface of the sheet. The sheet may include a fold line around which the sheet is folded. When the sheet is folded, the images on the surface of the sheet may be facing opposite directions and visible without opening the folded sheet. The surface of the sheet may therefore be viewed as an outer surface.

In some embodiments, the images may include elevated portions. The elevated portions may define the outlines of the images. The elevated outline portions may be a dark velvet material. In some embodiments, a user may color the images on the first sheet.

In some embodiments, the first sheet may include a holder for coloring instruments. The coloring instruments may be removed from the holder to color the first sheet.

The other surface of the first sheet may be left blank. Otherwise, the other surface of the first sheet may include text, such as a disclaimer, or an advertisement. The text on the other surface may be hidden when the first sheet is folded about the fold line. The text may only be shown when the sheet is opened to reveal the other surface. The surface may therefore be viewed as an inner surface.

The coloring book may include a second sheet. The second sheet may be the same dimensions as the first sheet. The second sheet may be made from a paper like material. The second sheet may include a fold line along the same axis as the first sheet. The second sheet may be folded along the fold line. When the sheet is folded, it may be inserted into the folded first sheet.

The fold lines of the first sheet and second sheet may be aligned. When the fold lines are aligned, staples may be used to fix the first sheet to the second sheet. The first and second sheets may thus form the outside cover and inner pages of a book.

The folded second sheet may define two pages, one on each side of the fold line. The second sheet may include perforations parallel to the fold line on each page. The perforations may allow a user to easily tear each page from the second sheet. The portion of the second sheet that is located between the two perforations may be left in the book when the pages are removed. The portion of the second sheet may be maintained in the coloring book by the staples fixing the second sheet to the first sheet.

One surface of the second sheet may include images defined by elevated outline portions. The second sheet may be fixed to the first sheet such that when the book is closed around the fold lines, the surface of the second sheet with the images is opposite the inner surface of the first sheet. This allows a user to see the image of the second sheet upon opening the book. This surface of the second sheet may therefore be viewed as the outer surface.

The other surface of the second page may be left blank. Printing on only one surface of the sheet may help reduce costs. This surface may therefore be viewed as an inner surface.

The coloring book may include a third sheet. The third sheet may be substantially identical to the second sheet. The third sheet may be inserted into the second sheet along the fold line. The only difference between the second sheet and the third sheet may be the orientation of the third sheet when it is included in the book.

Unlike the second sheet, the third sheet may include images on the surface that is hidden from view when the third sheet is folded along the fold line. This surface may therefore be viewed as the inner surface.

The other surface of the third sheet, which is visible when the third sheet is folded around the fold line, may be left blank. This surface may be viewed as the outer surface.

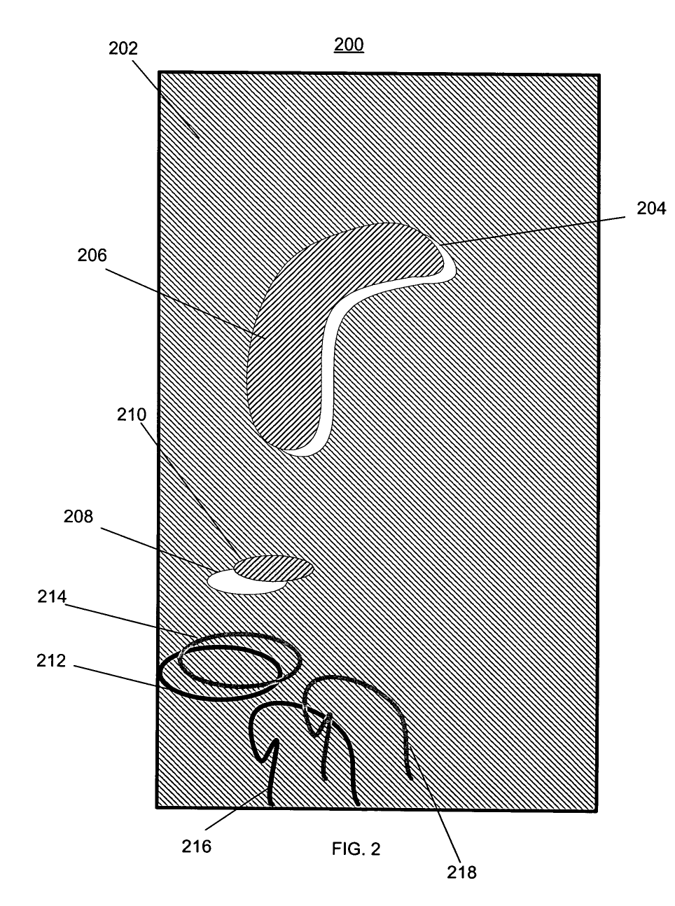

FIG. 2 shows elevated portion sheet 200, which may be used to create the foundation for an image having elevated portions (such as the images defined by elevated portions 114 and 124 of FIG. 1). In some embodiments, the coloring book may include one or more blank pages and one or more elevated portion sheets 200. Elevated portions sheet 200 may then be fixed (e.g., glued) to a page or such material (e.g., a thin paper stock). Accordingly, elevated portion sheet 200 may be attached to a sheet (e.g., sheet 100 of FIG. 1) or one or more pages (e.g., page 110 and/or page 120) or a book cover.

Elevated portion sheets 200 may also be provided separate from a coloring sheet or page to the user. As a result, a user may cut any suitable shape, such as shapes 206, 210, 214 and 218, from elevated portion sheet 200, leaving cutout portions 204, 208, 212 and 216, respectively, in the elevated portion sheet. Shapes 206, 210, 214 and 218 may be assembled and attached to a coloring page by a user to form an image for a user to color. Alternatively, the sheet having cutout portions 204, 208, 212 and 216 may be fixed to a sheet or page so that images are defined by these cutouts.

The coloring book may be provided with models for cutting elevated portion sheet 200. The models may allow a user to create shapes that may be combined to create a particular image. A model may be, for example, a stencil set, sample cutouts, cookie cutter type shapes, or any other suitable model. A model may be fabricated from, for example, any suitable material such as, for example, plastic, paper, cardboard, aluminum, metal, or any other suitable material. Such models may be removably attached to a page of a coloring book or included in a model container (or a coloring instrument container) that is fixed (or removable attached) to a part of the book. By including the models with the book, the models may be distributed with the book.

Elevated portion sheet 200 may be fabricated in any color, on any combination of colors. Elevated portion sheet 200 may be fabricated in any pattern or pattern of colors. Thus, a user may create shapes of different colors, or with certain patterns.

In some embodiments, elevated portion sheet 200 may be attached directly to a coloring book page. The elevated portion sheet may be attached using any suitable permanent or removable bonding such as, for example, glue, tape, heat treatment, sewing, Velcro, static cling, magnetic attraction, or any other suitable bonding. In some embodiments, the coloring book page may include a mechanical attribute that improves the fixation of the elevated portions shapes (e.g., shapes 206, 210, 214 and 218). In some embodiments, elevated portion sheet 200 may be provided with a male connector on its bottom surface, and the coloring book page may be provided with a female connector on its upper surface, such that the male connector is configured to be attached to the female connector. Alternatively, a shape could be provided in a shape container (or other container) that may be attached to the book. The cutouts may be substantially the same shape as the unobstructed portions defined by the cutouts of the elevated sheet. Thus, the shapes may be puzzle pieces and a puzzle dynamic may be integrated into the book.

In some embodiments, elevated portion sheet 200 may be provided with, or as, a sticker sheet (e.g., sticker sheet 402). Elevated portion sheet 200 may include a removable adhesive such that sheet 200, or portions of sheet 200 may be attached to a sheet or page. For example, sheet 100 of FIG. 1 or page 110 of FIG. 1 or page 120 of FIG. 1 may be fabricated by permanently fixing an elevated sheet having cutouts to another sheet. The shapes that fit into this cutout may include an adhesive that allows for it to be attached to the unobstructed portions of a sheet for distribution, but that may be removed by a user. Alternatively, sheet 200 may be attached to a sheet with an adhesive with a weak bond. Then, shapes may be cut into just sheet 200. As a result, a user may remove the shapes cut into sheet 200. If the adhesive chosen remains, at least in part, on the shapes, then the shapes may have the functionality of a sticker. The sheet attached to sheet 200 to form a page (e.g., page 110 of FIG. 1) or a sheet (e.g., sheet 100 of FIG. 1) of a coloring book may be coated on one side (or both sides or a portion of one or both sides) with a non-adhesive material such that an adhesive (e.g., the adhesive placed on sheet 200) will no bond with the non-adhering material. Thus, the adhesive material may be preserved until the shapes of sheet 200 are removed.

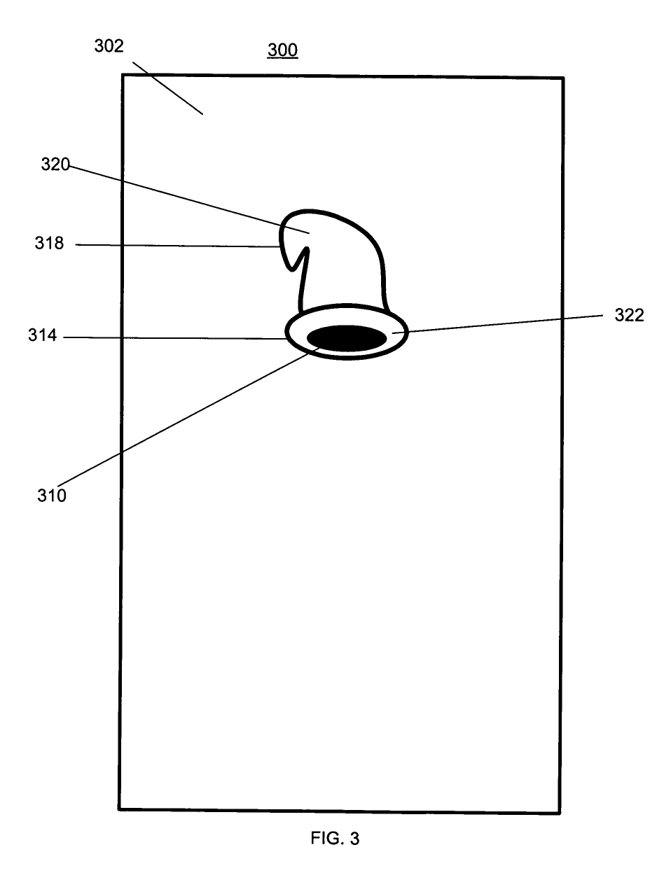

FIG. 3 shows coloring book portion 300, which includes page 302 to which shapes 310, 314 and 318, cut from elevated portion sheet 200 (FIG. 2), may be affixed to form hat 324. The shapes may define outlines for clear (e.g., unobstructed) portions 320 and 322 that a user may color.

A user may removably attach or permanently fix shapes 310, 314 and 318 to page 302 using any suitable adhesive or other material. The shapes may also be permanently fixed or removably attached to each other. Doing so may form, for example, a three-dimensional structure, thus giving depth to the image created or increasing the force applied to a coloring instrument when the coloring instrument tries to color outside of the clear (e.g., unobstructed) areas.

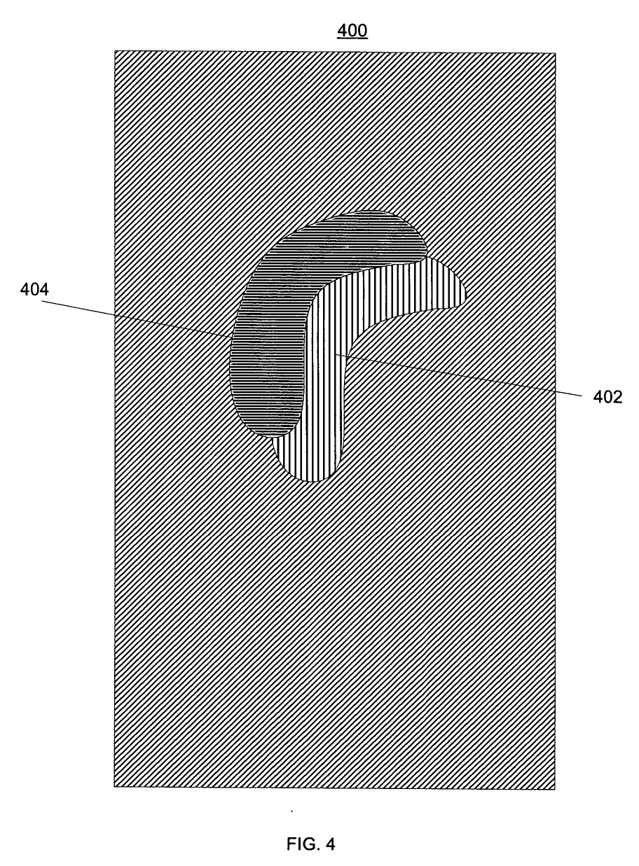

FIG. 4 shows coloring page 400, on which sticker portion 402 may be provided. In one embodiment, elevated outlines may be provided around sticker portion 402. Multiple sticker portions 402 may be utilized to create a single image. Stick portions 402, or a surface of sticker portions 402 may, for example, be fabricated with a paper that is operable to be colored. Thus, a user may color the sticker portions of an image, remove the sticker portions, and then reassemble the sticker portions elsewhere to recreate the colored image without the elevated outlines. Also, the elevated portions may be provided as stickers such that after an image is colored (or stickers are colored) the elevated portions may be removed to provide an image without any elevated portions. The bottom surface of sticker portion 402 may include any suitable adhesive to the page. Furthermore, the page may be configured to receive sticker portion 402 without retaining any substantial amount of adhesive when sticker portion 402 is removed. Additionally, the bottom surface of elevated portion 404 and/or the top surface of sticker portion 402 may include any suitable combination of any type of adhesive or adhesive-receiving material to attach, for example, elevated portion 404 to sticker portion 402.

Elevated portion 404 may be attached to sticker portion 402 to create an image on page 400. Elevated portion 404 may be removed once the user has finished coloring the image. In some embodiments, after removing elevated portion 404, the user may color sticker portion 402. In some embodiments, the user may remove sticker portion 402, and color the portion of page 400 that the sticker sheet covered. Sticker portion 402 and elevated portion 404 may then be re-used to create another image on a different page. Thus, any sticker or elevated portion may include, at least partially, a colorable material, any type of adhesive, or any type of material that will permanently, or temporarily, bond with an adhesive. Thin plastics, or other polymers, may be utilized and removably attached together via static bonds (e.g., static cling).

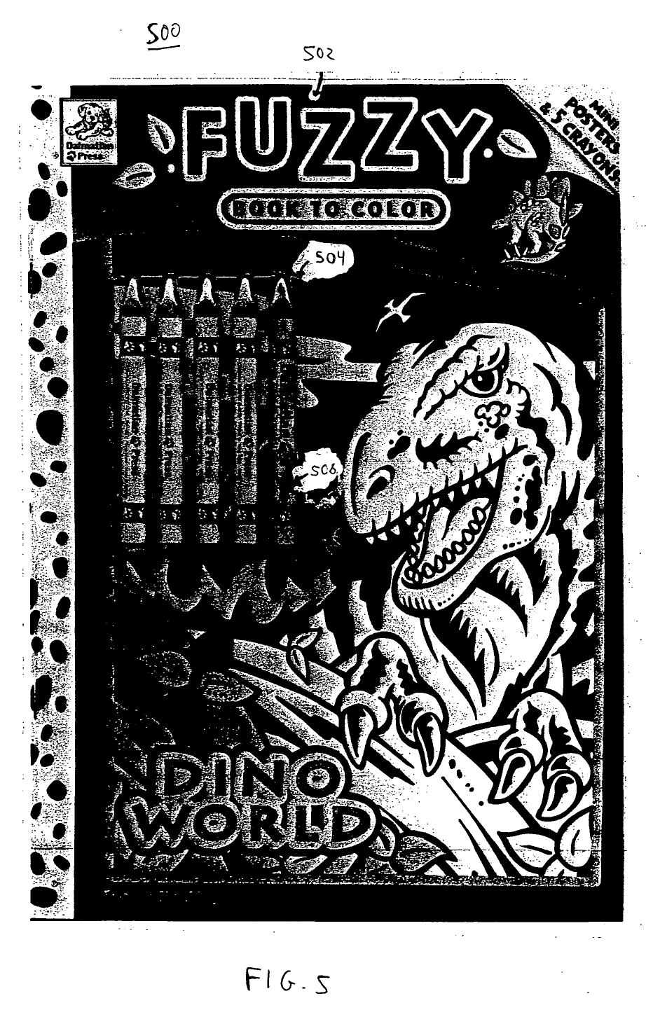

FIG. 5 shows front cover 500 of a coloring book with pages having elevated portions, such as pages 112 and 122 of FIG. 1 in accordance with the principles of the present invention. An elevated portion, such as elevated portion 502, may be included on the cover to make the user aware of the presence of elevated portions on the coloring sheets of the coloring book. The back cover of the coloring book may also include an elevated portion. In some embodiments, a user may color an image defined by elevated portions on the front or back cover of the coloring book. Accordingly, the front and/or back cover may be fabricated from a colorable material (e.g., an paper stock).

Front cover 500 may include a coloring instrument holder such as coloring instrument holder 504. Holder 504 may be permanently fixed to front or removably attached to cover 500 to house coloring instruments 506. Holder 500 may be any suitable coloring instrument holder such as, for example, a shell attached to the front cover, a Velcro strap, a bag, a sealable compartment, a protruding snap-fit holder, or any other suitable holder. The holder may be made from any suitable material such as, for example, plastic, paper, cardboard, Velcro, metal, fabric, or any other suitable material. The holder may be attached to the cover by any suitable adhesive, binding, or other types of attachments.

In some embodiments, the holder may include one or more projection having a plurality of holes for retaining a plurality of coloring instruments. Holes may be created, for example, by cutting the cover. A pair of holes may be used, for example, to secure a portion of a coloring instrument to a cover. The dimensions of the plurality of holes may be configured to be slightly less than the dimensions of the plurality of coloring instruments, such that the coloring instruments may be held in a press-fit relation in the projection. Each of the plurality of holes may have different shapes and sizes, each corresponding to the shape and size of a coloring instrument to be retained. The projection may be permanently or removably attached to front cover 500 at any suitable location such as, for example, the inside cover, the side of the cover, the outside cover, or any other suitable location. In some embodiments, the projection may include an overhanging portion.

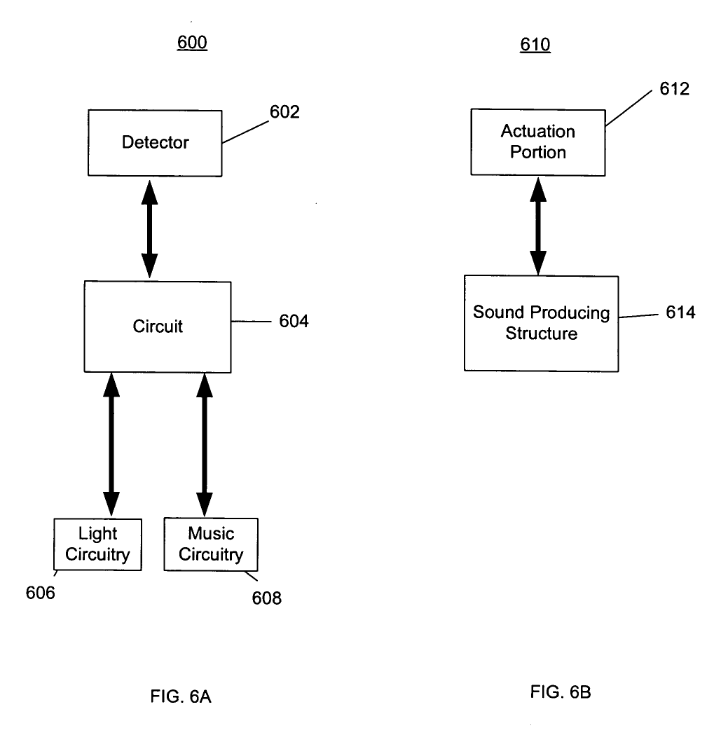

FIG. 6A shows musical and/or light system 600 which may be removable attached to, permanently fixed to, or embedded in a coloring book in accordance with the principles of the present invention. Musical and/or light system 600 may include detector 602, circuit 604, music circuitry 606 and light circuitry 608. Detector 602 may be operable to detect an action by a user to the coloring book such as, for example, opening the cover (e.g., via a photosensitive element such as a photoresistor, a mechanical switch circuit that produces a current and/or voltage when closed, or a magnet and accompany Hall Effect Transistor), picking up the coloring book (e.g., via a weight sensor), pushing a button that produces an electrical signal, or any other type of action and accompanying sensor. Detector 602 may be, for example, a mechanical sensor, electrical sensor, magnetic sensor, light sensor, temperature sensor, or any other suitable means. A power source (not shown) may be provided to supply power to detector 602 or any other circuit or element of system 600. Detector 602 may be configured to send a signal to circuit 604 upon, detection of an action. Circuit 604 may send a subsequent signal to music producing circuit 606 and/or light producing circuit 608 for music and/or light to be emitted from the coloring book. A music circuit may, for example, include a memory, speaker, encoding circuitry, amplifier, and/or any other type of component for producing sound and any combinations thereof. Music may be stored in the memory in the form of, for example, analog or digital voice signals. A light circuit may include, for example, an LED, laser, light producing component, fluorescent light, and/or and driving circuits or combinations thereof. Circuit 604 may be included in system 600 and may be, for example, a microprocessor or other circuitry for facilitating or controlling the operation of system 600. Alternately, any other suitable output may be produced by a source upon detection of an action by detector 602.

FIG. 6B shows sound device 610 that may be removably attached to, permanently fixed to, or embedded in a coloring book in accordance with the principles of the present invention. The sound device may be implemented on any suitable portion of the coloring book such as, for example, the front cover, the back cover, a coloring page, an elevated portion, or any other suitable portion. Sound device 610 may be similar to system 600.

Sound device 610 may make any suitable sound such as, for example a squeaking, creaking, singing, or any other suitable sound such as voice or music. Sound device 610 may be incorporated in the coloring book such that the sound made by sound device 610 corresponds to an image or theme of the coloring book. In some embodiments, the elevated portion material may define a maze at the end of which a button may be actuated to produce a sound such as, “Congratulations,” “You did it!,” music, or any other suitable sound. In some embodiments, sound device 610 may provide music or sound corresponding to the drawing depicted on the page (e.g., the sound of the ocean, a roar of an animal, the name of an object, letters, numbers, etc.). Sound device may be electrical in nature or may be mechanical (e.g., when squeezed air is released through a mouth that is shaped to create a noise).

Sound device 610 may include actuation portion 612 and sound producing structure 614. Actuation portion 612 which may be, for example, a button, lever, string, balloon, or any other suitable mechanism that may be actuated by a user, may be connected to sound producing structure 614 such that sound producing structure 614 makes a sound in response to an actuation of actuation portion 612. Actuation portion 612 may be actuated by any suitable means such as, for example, mechanical, electrical, magnetic field, light, darkness, temperature, or any other suitable means. In some embodiments, actuation portion 612 may be incorporated in sound producing structure 614. Sound producing structure 614 may be any structure that creates a sound when actuated by an actuation portion. The sound created by sound producing structure 614 may be any suitable sound, at any suitable volume. In some embodiments, sound producing structure 614 may include, for example, a hollow plastic bulb which makes a sound when an actuation portion pushes air out of the bulb. In some embodiments, sound producing structure 614 may include, for example, an electric circuit, which may be configured to play any suitable sound such as, for example, a musical tune, a song, an animal sound, a voice, or any other suitable sound.

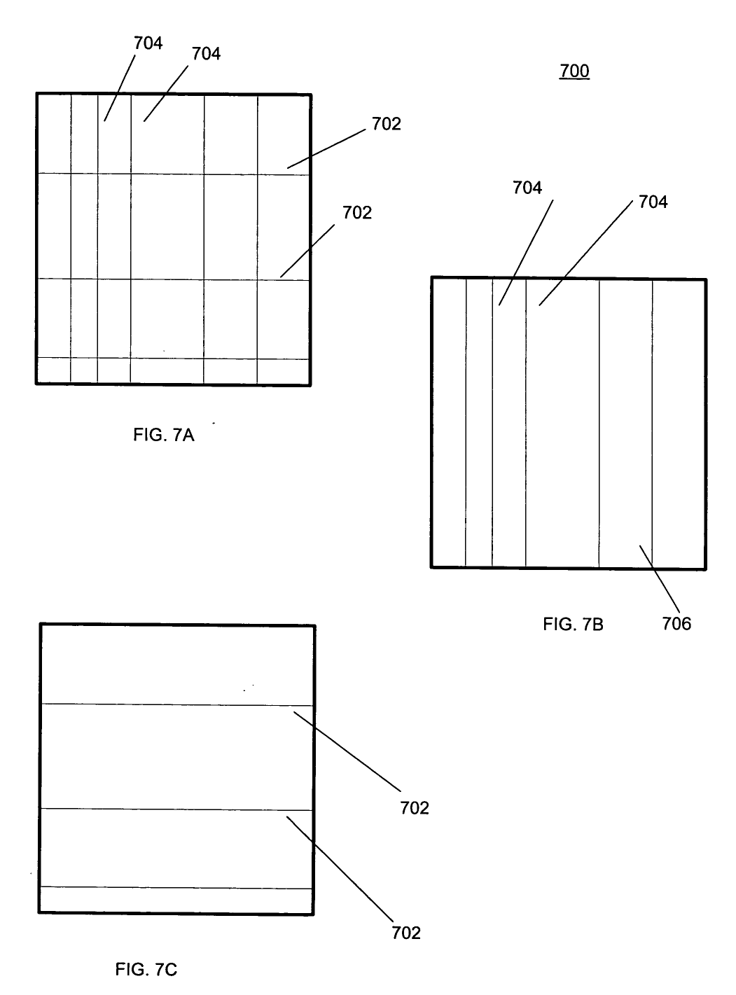

FIG. 7A shows portion 700 of a coloring book. Portion 700 may be a portion of clear (e.g., unobstructed) space that may be colored by a user, an elevated portion, or any combination thereof. Portion 700 may include an image made from lines 702 and 704, which may be different colors. Lines 702 may define an image that may be hidden among lines 704 such that the image is not easily visible. For example, in some embodiments, red lines 702 may define an image that is hidden among blue lines 704.

The coloring book may also include film 706, shown in FIG. 7B, which may be designed to hide lines 704 such that lines 702 and the image they define may be revealed. Film 706 may be a translucent or transparent film. Film 706 may be the same color as lines 704. Film 706 may be stored in any suitable portion of the coloring book such as, for example, on the cover, on a separate page, inside the cover, or any other suitable location. Film 706 may be at least partially attached to any portion of the book (e.g., the front or back cover), and detachable by a user to view a hidden image. Film 706 may be removed from its storage location and placed over any suitable portion of the coloring book.

When film 706 is placed over portion 700, lines 704 may be obscured by the film such that only lines 702 remain visible, as shown in FIG. 7C, revealing an image. The image defined by lines 702 may be any suitable image, for example a solution to a game. For example, in some embodiments, a portion of the coloring book may form a maze for a user to navigate. Lines 702, hidden among lines 704, may show the solution to the maze, or an image related to the particular location in the maze (e.g., a treasure chest, a crocodile, a hidden boat for crossing a river, etc.). Film 706 may reveal the solution or hidden image to the user when the film is placed over the page.

In some embodiments, the coloring book may include problems for a user to solve, such as mathematical, spelling, grammatical, word, or any other suitable problem. The problems may be printed and visible for the user, and the solution of the problem may be hidden using lines 702 among lines 704. The user may then check or view the answer to a problem by placing film 706 over the page to reveal lines 702.

Film 706 may be in the form of glasses. For example, the glasses may be attached to the book (or placed in a holder) and removed by the user for viewing the hidden images. Film 706 may be the lenses of the glasses.

In some embodiments, the image may be defined by the lines drawn with different colors so that when a user views the lines through film 706 or glasses with a film, the image appears to be three-dimensional.

In some embodiments, the book may include images on a page or sheet that are drawn using invisible ink. The invisible ink may be used on the unobstructed portion or on the elevated portion. The invisible ink may be revealed using a second, revealing ink that may be provided with the book. For example, the book may include a container attached to any suitable portion of the book (e.g., the cover) that contains ink for revealing invisible images. The revealing ink may be applied on the unobstructed portions and elevated portions using any suitable coloring instrument such as, for example, a pen, a paintbrush, etc.

In some embodiments, film 706 in the glasses may be a colored film, for example a green film. The image on the page or sheet may be made from lines in another color (e.g., red) that are hidden among lines of the color of the film (e.g., green). When the user puts on the glasses and looks at the page or sheet through the glasses, the lines that are the same color as the film (e.g., green) may be blended with the perspective of the user such that only the lines of the other color (e.g., red) are visible to the user. Thus, the image that was previously hidden may be revealed. The colors used may be blue and red.

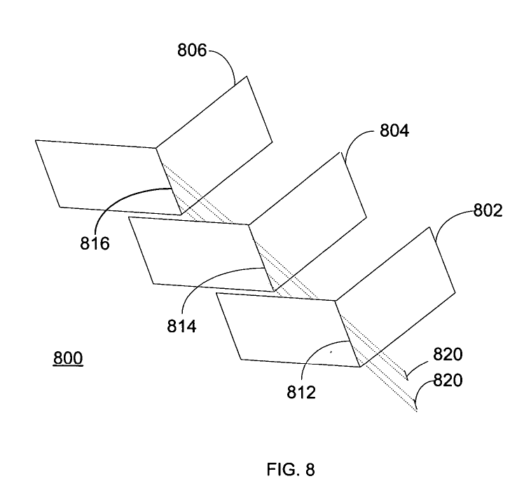

FIG. 8 shows an expanded view of coloring book 800 that is formed from three sheets. Coloring book 800 may be formed from any suitable number of sheets. In the example shown in FIG. 8, only three sheets are used. Sheet 802 may be the cover sheet of the book. Sheet 802 may therefore be fabricated from a cardboard like material. Sheet 802 may include a fold line 812 around which sheet 802 is folded to create two pages.

Coloring book 800 may also include two interior sheets 804 and 806. Each interior page may be folded around fold line 814 and 816, respectively to create four interior pages. Any combination of the interior pages may include images and elevated outline portions for a user to color. In some embodiments, the coversheet may include images and elevated outline portions for the user to color.

The sheets forming the coloring book may be attached to each other by one or more staples 820. The staples may be aligned with the fold lines of the sheets to allow the sheets to be easily folded and unfolded by a user to reveal the various pages.

From the foregoing description, persons skilled in the art will recognize that this invention provides a coloring book with elevated portions to facilitate coloring. In addition, persons skilled in the art will appreciate that the various configurations described herein may be combined without departing from the present invention. It will also be recognized that the invention may take many forms other than those disclosed in this specification. Accordingly, it is emphasized that the invention is not limited to the disclosed methods and systems, but is intended to include variations to and modifications thereof which are within the spirit of the following claims.

1. A coloring book comprising:
a book cover;
an interior sheet having a first page and a second page, wherein the first page and the second page are defined by a fold line in the interior sheet;
a first image on the first page, the boundaries of which are defined by a first elevated portion attached to the first page; and
a second image on the second page, the boundaries of which are defined by a second elevated portion attached to the second page.

2. The coloring book of claim 1 wherein the elevated portion is made from velvet material, plastic, or paper.

3. The coloring book of claim 1 wherein the elevated portion is dark, light, or a combination of light and dark in color.

4. The coloring book of claim 1 wherein the first elevated portion is permanently fixed or removably attached to the first page.

5. The coloring book of claim 1 wherein a coloring instrument abuts the elevated portion when the coloring instrument attempts to overstep the elevated portion.

6. The coloring book of claim 1 wherein a portion of the coloring book comprises a mechanism for producing a sound or light.

7. The coloring book of claim 6 wherein the mechanism produces music.

8. The coloring book of claim 6 wherein the mechanism is activated mechanically, by light, by darkness, by a magnetic field, or by an actuation mechanism.

9. The coloring book of claim 6 wherein the portion of the coloring book is the book cover or an interior sheet.

10. The coloring book of claim 1 further comprising a film configured to reveal an image hidden in a portion of the coloring book by placing the film over the image.

11. The coloring book of claim 10 wherein the film is colored.

12. The coloring book of claim 1 further comprising a coloring instrument holder attached to a portion of the book.

13. The coloring book of claim 12 wherein the holder is closable or reusable.

14. The coloring book of claim 14 wherein the holder comprises a projection from the surface of the coloring book.

15. The coloring book of claim 12 wherein the portion is the book cover or an interior sheet.

16. A coloring book comprising:
a book cover having a cover sheet having a first cover page and a second cover page, and wherein the first cover page and the second cover page are separated by a cover fold line;
an interior page sheet having a first page and a second page, wherein:
the first page and the second page are separated by a page fold line;
at least a portion of the cover fold line and the page fold line are fixed together by a staple; and
the first page and the second page are separated from the page fold line by first and second perforations parallel to the page fold line;
a first outline of a picture that is fixed to the first page such that portions of the first outline are elevated from the first page;
a second outline of a picture that is fixed to the second page such that portions of the second outline are elevated from the second page, wherein the portions of the first and second outlines that are elevated are fabricated from a velvet material.
